(19) United States
(12) Patent Application Publication
(10) Pub. No.: US 2013/0262131 A1
(43) Pub. Date: Oct. 3, 2013

(54) TENANT SCREENING METHOD AND SYSTEM USING PERSONALITY ASSESSMENT

(71) Applicant: Rhys Lewis, Nanaimo (CA)

(72) Inventor: Rhys Lewis, Nanaimo (CA)

(21) Appl. No.: 13/436,969

(22) Filed: Apr. 1, 2012

(51) Int. Cl. G06Q 99/00

(52) U.S. Cl. 705/1.1

(57) ABSTRACT

A system and method of using a computer and computer program for rapid tenant screening using a personality assessment. The personality assessment measures tenant characteristics then weights those characteristics to predict tenant behaviors of interest to landlords. The tenant is invited to participate in a personality assessment. The computer software and processor generates an assessment report for the landlord indicating the strengths and weaknesses of the tenant's profile. The landlord uses that profile as selection criteria affecting acceptance decision.

### FIELD OF THE INVENTION

This invention relates to business practice and management in the field of risk processing and in particular to a tenant screening method and system using a personality assessment.

### BACKGROUND OF THE INVENTION

The residential and commercial real estate management industry consists of properties with rental tenants that are screened and managed by a landlord. Prior tenant screening generally included an in-person meeting, an application form, and possibly a reference screen and/or credit screen. Tenant screening constitutes a long and arduous process with an often unsuccessful outcome. Furthermore, this process was often the subject of charges of discrimination. Therefore there remains a need to improve the tenant selection process.

The employee screening industry shares a common goal with the tenant screening industry: to differentiate suitable individuals from unsuitable ones. Personality assessments designed to evaluate the suitability of prospective employees are becoming increasingly popular with employers due to their high validity, low cost, and low adverse impact. Despite their usefulness in the employee screening industry, personality assessments have never been developed for or applied in the tenant screening industry. The personality assessment component of the current invention was constructed using theories and methods that underlie all scientifically developed assessments of individual characteristics (e.g., classical test theory, scientific research method). The current invention differs from all prior assessments in three main ways: content, target audience, and platform of delivery. Content is different because many behaviors that are relevant in tenant screening (e.g. punctuality with payments, conscientious use of utilities) do not have analogues in employee screening. Consequently, assessments for prospective tenants require inclusion of different sets of personality traits and behavioral outcomes than assessments for prospective employees. Selection of relevant behaviors and personality traits for the current invention is the result of two years of proprietary research. Target audience differs from all prior assessments in that tenant screening is a separate industry from employee screening. The industries are governed by separate laws, have separate professional and regulatory bodies, and have little or no crossover in methods or research. The platform of delivery the software component of the current invention—was developed entirely and solely for use in applying personality assessments in tenant screening. It has no analogue in employment.

### OBJECTS OF THE INVENTION

It is one object of the invention to improve the tenant selection process for rental units.

A second object is to integrate a personality assessment into a tenant selection process.

A third object of the invention is to allow the landlord the opportunity to provide weight factors to desirable and undesirable characteristics of prospective tenants in a screening process.

A forth object is to save the landlord time in assessing a prospective tenant.

A fifth object is to automate the tenant selection process.

A sixth object is to increase the fairness of the tenant selection process by reducing adverse impact on minorities relative to other tenant screening processes.

### SUMMARY OF THE INVENTION

The present invention provides a method and system for selecting a prospective tenant for a rental unit. The invention screens prospective tenants applying for residential or commercial tenancy using a personality assessment. The personality assessment measures characteristics relevant to behaviors landlords care about. Characteristics include personality traits, attitudes, judgments, and candidness of responses on the assessment. This process is an improvement over existing tenant screening processes that rely on interviews, reference checks, credit checks, application forms, criminal record checks, rental history and/or past eviction checks.

In one embodiment of the invention there is disclosed a method for evaluating the suitability of a prospective tenant for a rental unit based on results of a personality assessment. The method comprises the use of a computerized selection system comprising computer processors and software programs. The landlord identifies a prospective tenant. The system of the invention comprises an Internet portal so that the landlord can access the computerized selection system to assess the suitability of the tenant. The landlord signs into the system through the Internet portal using a username and password. An invitation is sent to the prospective tenant by email or by other means such as telephone or mail. The tenant is provided an authorization code permitting the tenant to log into the system Internet portal and gain access to the assessment forms. The forms comprises upwards of 100 to 200 statements. The prospective tenant responds to the statements online and the server records the response. The invention then applies a proprietary scoring algorithm to provide the landlord a score indicative of the suitability of the tenant. The assessment comprises statements that are related to desirable and undesirable tenant characteristics. Measurements of the characteristics are used to predict behaviors of interest to landlords. The landlord has the opportunity to customize the importance weights of behaviors in order to personalize scoring to reflect the landlord's values.

A score sheet is presented to landlords that graphically presents and compares the scores for each of the prospective tenants under consideration.

A system is also disclosed for evaluating the suitability of a prospective tenant for a rental unit by a landlord using a personality assessment. The system comprises a computerized selection system comprising: computer processing modules; software program modules; and, memory modules. The system also comprises an Internet portal so that the landlord and the prospective tenant can access the computerized selection system. The landlord uses an invitation module for generating an invitation to the prospective tenant to participate in the assessment. A security module provides for permissions-based access to the Internet portal and the system server for both the landlord and prospective tenant. The prospective tenant accesses a personality assessment module and by completing the assessment generates a dataset. The software modules execute a proprietary dataset scoring module and a report generating module for the landlord.

### BRIEF DESCRIPTION OF THE DRAWINGS

FIG. 1 illustrates one embodiment of an Internet portal of the invention for landlords and tenants.

FIG. 2 illustrates one embodiment of a landlord enrollment process.

FIG. 2A illustrates one embodiment of a landlord login screen of the invention.

FIG. 3 illustrates one embodiment of a “Signup” page of the invention.

FIG. 4 illustrates one embodiment of a “My units” page of the invention.

FIG. 5 illustrates one embodiment of a screen for modifying the importance weights of behaviors and sub-behaviors.

FIG. 5A illustrates one embodiment of a screen for choosing the comparison sample used in scoring algorithms.

FIG. 6 illustrates one embodiment of an “Inbox” page of the invention.

FIG. 7 illustrates one embodiment of a form for inviting candidates via email to complete a personality assessment.

FIG. 8 illustrates one embodiment of a form for inviting candidates via phone or in person to complete a personality assessment.

FIG. 9 illustrates one embodiment of a prospective tenant login screen of the invention.

FIG. 10 illustrates one embodiment of a personality assessment of the invention.

FIG. 10A illustrates a partial list of lead-in statements of one embodiment of the invention.

FIG. 11 illustrates a partial list of sub-behavior names and definitions of one embodiment of the invention.

FIG. 12 illustrates one embodiment of a list of scale names and definitions of the invention.

FIG. 13 illustrates one embodiment of a list of items/statements of one embodiment of the invention.

FIG. 14 illustrates a list behavior names and definitions of one embodiment of the invention.

FIG. 15 illustrates one embodiment of an assessment report generated by the system of the invention.

FIG. 16 diagrams one embodiment of the personality assessment process of the invention from the perspective of a landlord.

FIG. 17 diagrams one embodiment of the personality assessment process of the invention from the perspective of a prospective tenant.

### DESCRIPTION OF THE INVENTION

In this submission, the term “landlord” refers to a landlord and/or the landlord's agent (e.g., property manager, building manager, site manager).

The description contained in this application is exemplified by references to a residential landlord situation where a tenant seeks to rent accommodation. However, it is to be understood that the invention can be applied to commercial real estate markets where a tenant may wish to rent office space.

The invention provides landlords with a method and system for assessing the suitability of a prospective tenant based on a personality assessment. The personality assessment measures characteristics of perspective tenants that predict behaviors of relevance to landlords. Characteristics include personality traits, attitudes, judgments, and candidness of responses on the assessment. The landlord is provided access to a system of the invention comprising a computerized selection system. The computerized selection system is comprised of computer processing modules, data storage modules, and software program modules.

The invention is intended to be one component in a larger battery of tenant screening tools. To make use of the current invention, landlords would apply the method and system of the invention at the time of their choice during their screening battery. Landlords retain control over which other screening methods and systems are applied (e.g., in-person meetings, credit checks, reference checks, past eviction checks, criminal record checks), and the order of administration of those screening tools. For instance, one landlord may invite prospective tenants who pass the in-person interview to take the personality assessment described in this application. People who pass the assessment might then be asked to consent to a credit check. Alternatively, another landlord may use the personality assessment of the invention as an initial pre-screen, then chose to meet only with prospective tenants who pass the personality assessment. Yet another landlord may administer to all prospective tenants a reference check, past eviction check, and the personality assessment of the invention. In other words, landlords choose when and how the current invention fits into their larger tenant screening battery.

### Initial Access

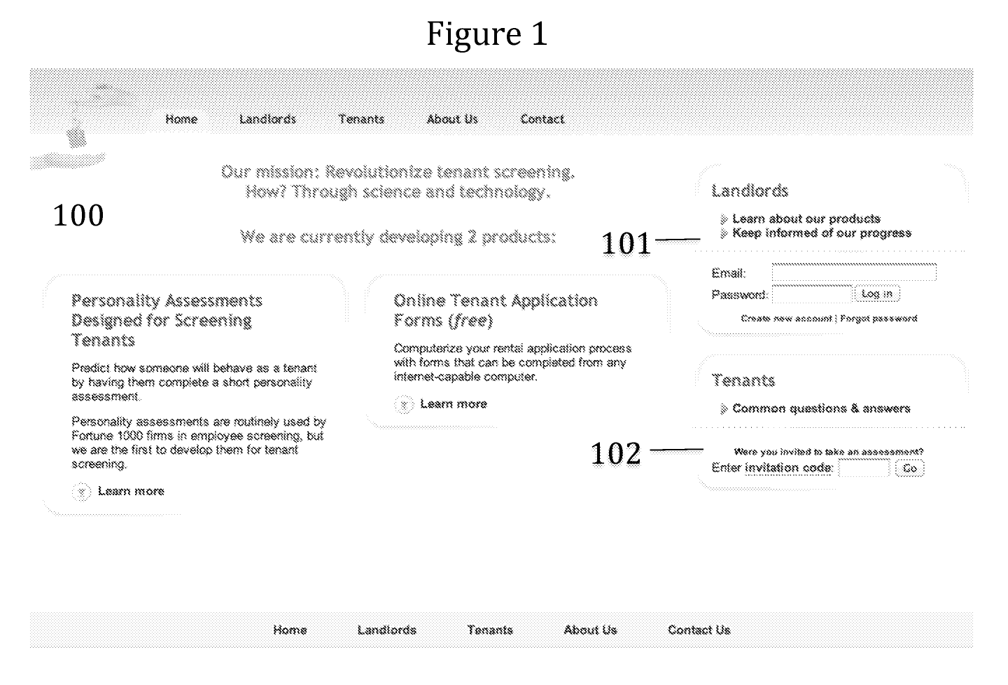

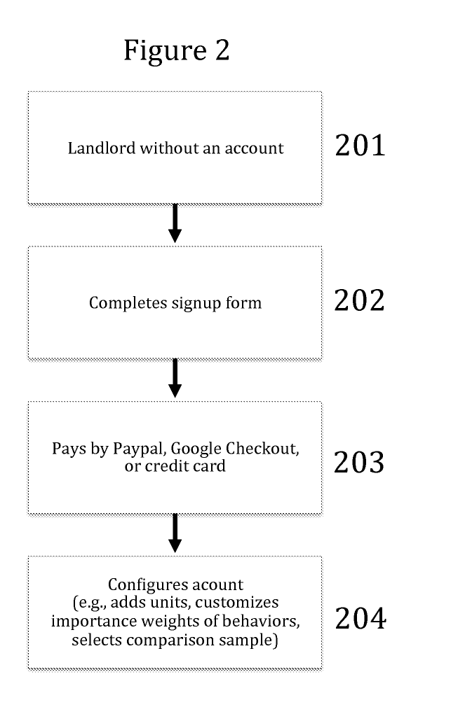

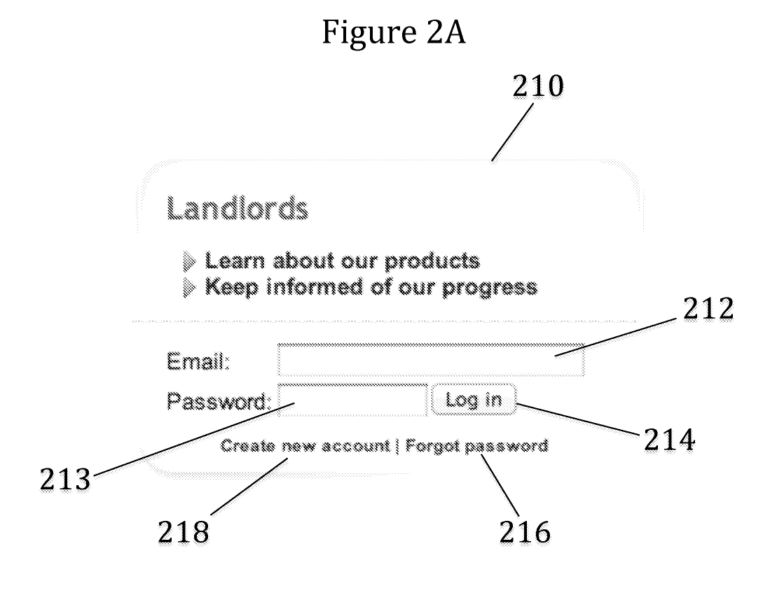

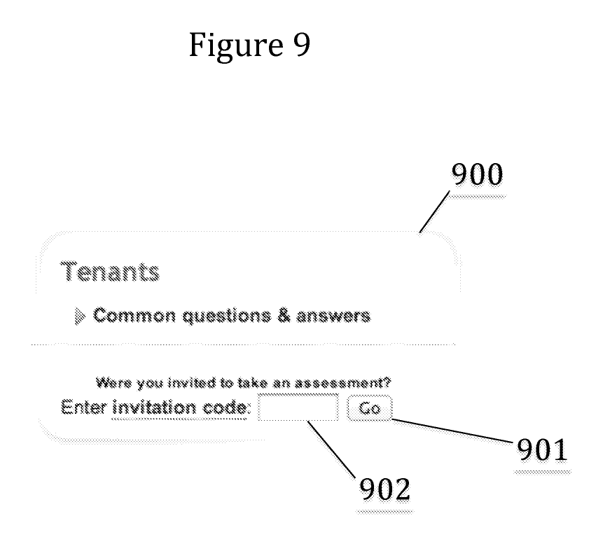

Landlords and prospective tenants access the system through an Internet portal. One embodiment of the Internet portal is illustrated in FIG. 1 and screen 100. FIG. 1 also shows the landlord login screen 101 and prospective tenant login screen 102. The access to the system and method of the invention is permissions based and the invention comprises a security module so that the landlord and the tenant can only gain access to the system and method of the invention by entering valid credentials. FIG. 2A illustrates the login screen 210 used by the landlord. FIG. 9 illustrates the login screen 900 used by the tenant.

### Enrollment

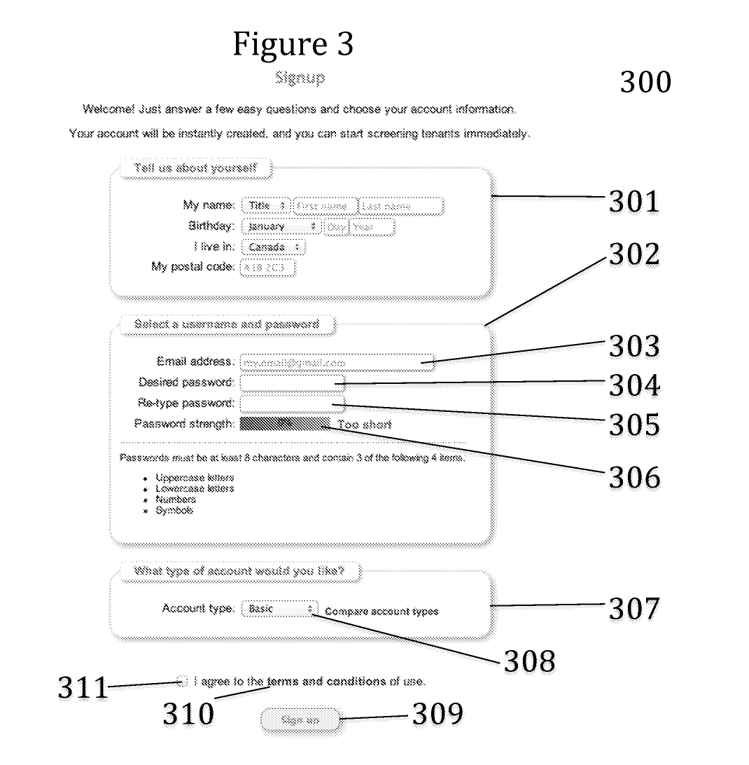

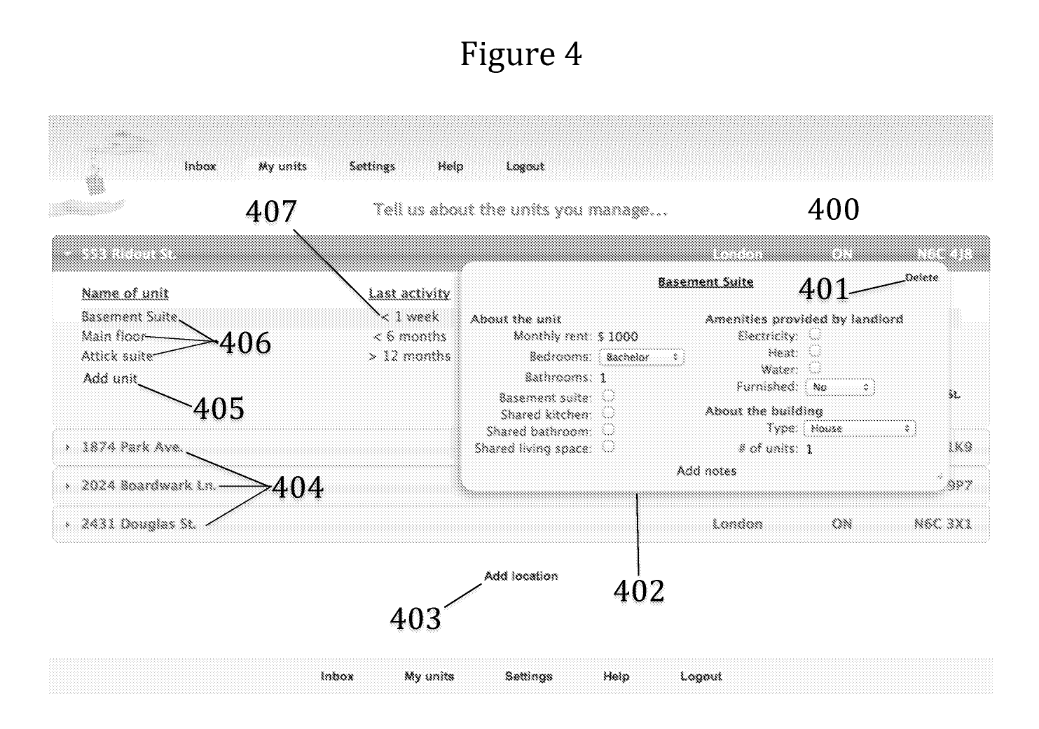

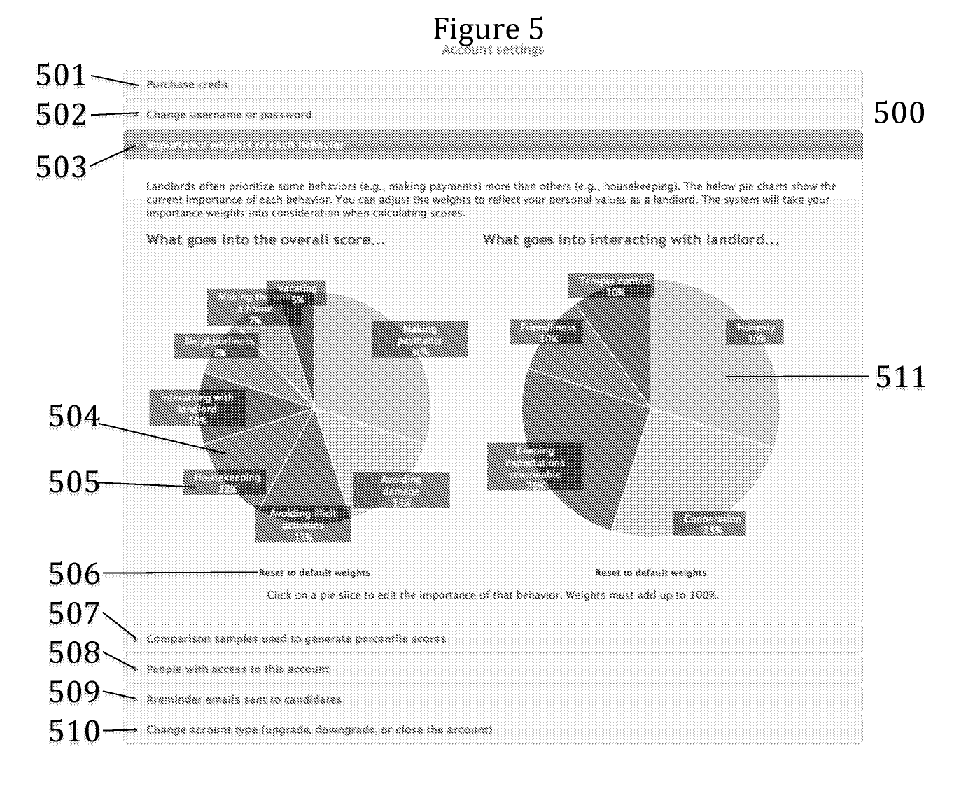

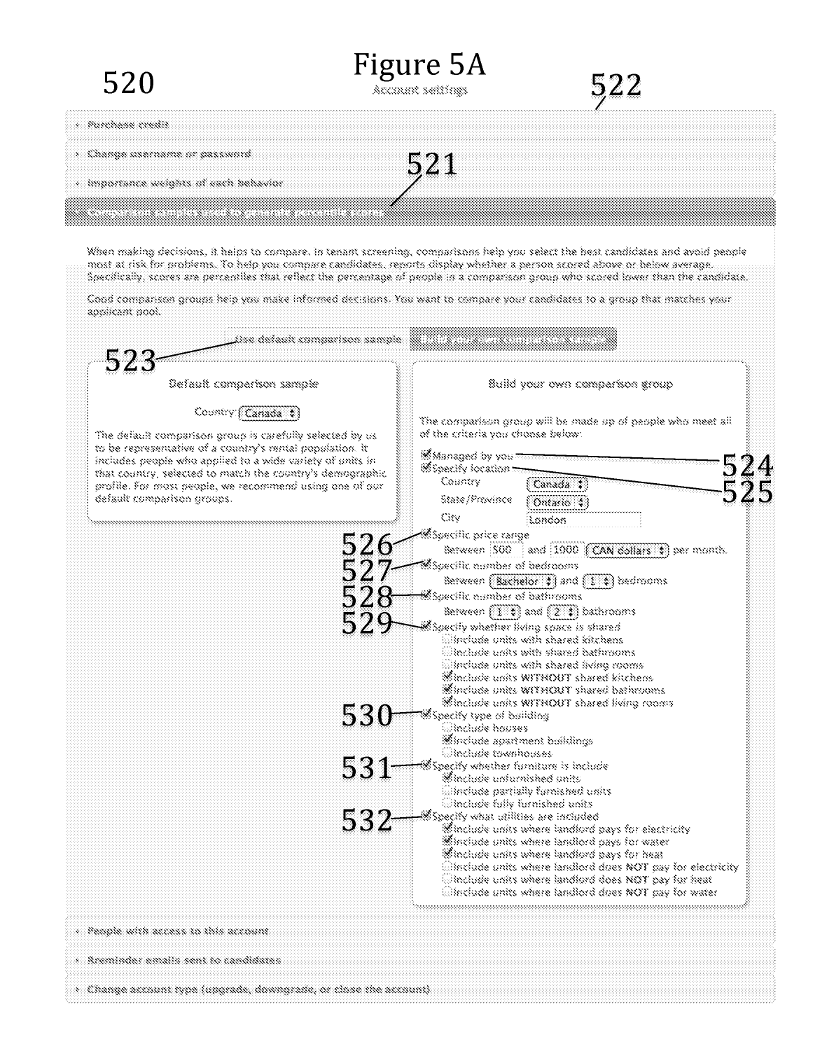

The enrollment process is diagrammed in FIG. 2 and relies upon an enrollment module as part of the system. A landlord without an account 201 becomes a client of the system by enrolling using the system signup page 202 (illustrated in FIG. 3), providing payment information 203, then configuring some initial settings for their account (204 illustrated in FIGS. 4, 5, and 5A). After enrolling, the system and method of the invention are accessible by the landlord on a fee for services basis or on a subscription basis through a payment module.

If the landlord is accessing the portal for the first time then he or she must create a new account. Referring to FIG. 2A and the landlord login screen (210), the “Create new account” link 218 takes the landlord to the “Signup” page (FIG. 3 and screen 300). The “Tell us about yourself” section 301 of the Signup page collects basic personal information such as name, birthdate, and location of residence. The “Select a username and password” section 302 of the Signup page activates a security module and asks landlords to provide their email address 303, choose a desired password 304, and confirm the desired password 305. A password strength meter 306 helps landlords choose a password that meets security best practices. The “What type of account would you like” section 307 asks landlords to choose an account type from a drop-down menu 308. Available account types include various levels of subscription-based accounts billed periodically, as well as fee for use accounts for occasional users. In another embodiment of the invention, there may be a facility to provide a free screening service on a promotional basis. The payment means is controlled by the payment module of the system. Landlords are given a link 310 to the terms and conditions of service, and must agree to those terms by checking a checkbox 311 before submitting their information by pressing the signup button 309. Because the invention is going to be revenue positive, after completing the “Signup” page, the landlord will provide a method of payment—either PayPal account information, Google Checkout account information, or a credit card number—through a secured window as shown in FIG. 2, step 203.

### Initial Account Configuration

After completing the “Signup” page and providing payment information, there are some initial settings landlords use to customize their account: “My units” (FIG. 4), “Importance weights of each behavior” (FIG. 5), and “Comparison samples used to generate percentile scores” (FIG. 5A).

### My Units.

The first screen new account holders see is the “My units” page (FIG. 4 and screen 400). The screen lists all the locations 404 that a landlord managers. In the embodiment of the “My units” page illustrated in FIG. 4, locations are displayed as elements in an accordion display that shows information for the active location. Each location (e.g., 553 Ridout St., London, Ontario) can have multiple units 406 (e.g., basement suite, attic suite, main floor suite). Landlords can “Add locations” 403 and “Add units” 405 to their account. A screen 402 appears upon the curser hovering over a unit that allows landlords to manage the information for that unit as well as delete the unit 401. Landlords can return to the “My units” page at any time after login to manage their location and unit information stored in the system of the invention.

### Importance Weights of Each of the Behaviors.

Referring to FIG. 5, landlords often prioritize some tenant behaviors (e.g., making payments) more than others (e.g., housekeeping). These priorities are a matter of personal preference and are highly specific to each individual. Landlords who hold feature rich account types are able to customize the importance weights given to each of the behaviors using a weighting module of the system. The system then takes those importance weights into account when producing scores that represent a prospective tenant's suitability to that landlord.

Importance weights of behaviors are managed on the “Importance weights of each behavior” tab 503 of the “Account Settings” 500 page. The illustrated pie charts 504 and 511 display how heavily each main behavior category is weighted by the landlord in calculations of overall score (pie chart 504), and how heavily each sub-behavior is weighted by the landlord in calculations of main behavior category scores (pie chart 511). Exact percentages are shown in pie chart labels 505. Landlords can click on any slice of the pie chart in order to change the importance weight of the given behavior. Landlords can also click on the “Reset to default weights” link 506 to reset the weights to their default configuration.

### Comparison Sample Used to Generate Percentile Scores.

To facilitate interpretation of assessment results, scores displayed to landlords are comparative in nature. They reflect how a prospective tenant scored relative to other prospective tenants (Below Average to Above Average). Specifically, scores represent the percentage of people in a comparison sample who scored lower than the prospective tenant. Comparative information is most useful when the comparison sample closely matches the landlord's applicant pool.

Referring to FIG. 5A, the “Comparison samples used to generate percentile scores” tab 521 of the “Account Settings” page accordion 522 displays options for selecting comparison samples. The default setting 523 is for landlords to use a country-specific “default comparison sample.” Those “default comparison samples” are selected by the system to be representative of the country's rental population. Default samples include the most recent prospective tenants who applied to a variety of units, with care taken so that the demographic composition in the comparison sample reflects the demographic composition of that country's rental population.

Alternatively, landlords with feature-rich accounts are able to apply a customized comparison sample using a sample customization module of the system. Still referring to FIG. 5A, customized comparison samples allow landlords a high level of control over who will be included in the comparison sample. In the embodiment of the invention shown in FIG. 5A, the landlord may decide to only include prospective tenants in the comparison sample who applied to:
Units managed by himself/herself 524
Units within a certain location 525 (e.g., country, state/province, city)
Units within a given price range 526
Units with a certain number of bedrooms 527
Units with a certain number of bathrooms 528
Units with (or without) shared living spaces 529
Units within certain types of buildings 530 (e.g., house, apartment building, townhouse)
Units with (or without) furniture included 531
Units with (or without) certain utilities paid for by the landlord 532

### Landlord Login

The sections described so far have focused on initial account creation and configuration. Once a landlord has created an account and configured it to his or her satisfaction, he or she can login at any time. Login is required to manage the account and to apply the invention to screen prospective tenants.

As shown in FIG. 2A, the login form 210 contains two primary data fields: one for the email address 212 of the account holder and another for the account holder's password 220. The password is an alphanumeric code that was chosen by the landlord during the enrollment process. Once the email and password are entered, the landlord clicks on the “Log in” button 214.

### Password Reset

There is also a facility on the login window FIG. 2A screen 210 to reset a forgotten password 216. The forgotten password link 216 directs account holders to a password reset page. On the password reset page, account holders enter their primary email address and request an email containing a password reset link. The system then sends the landlord an email containing a password reset link. Upon clicking on the password reset link contained in the email, the account holder is directed to a page on which he or she can input a new password. After successfully choosing a new password, the account user is automatically logged in to their account on the system.

### Inbox

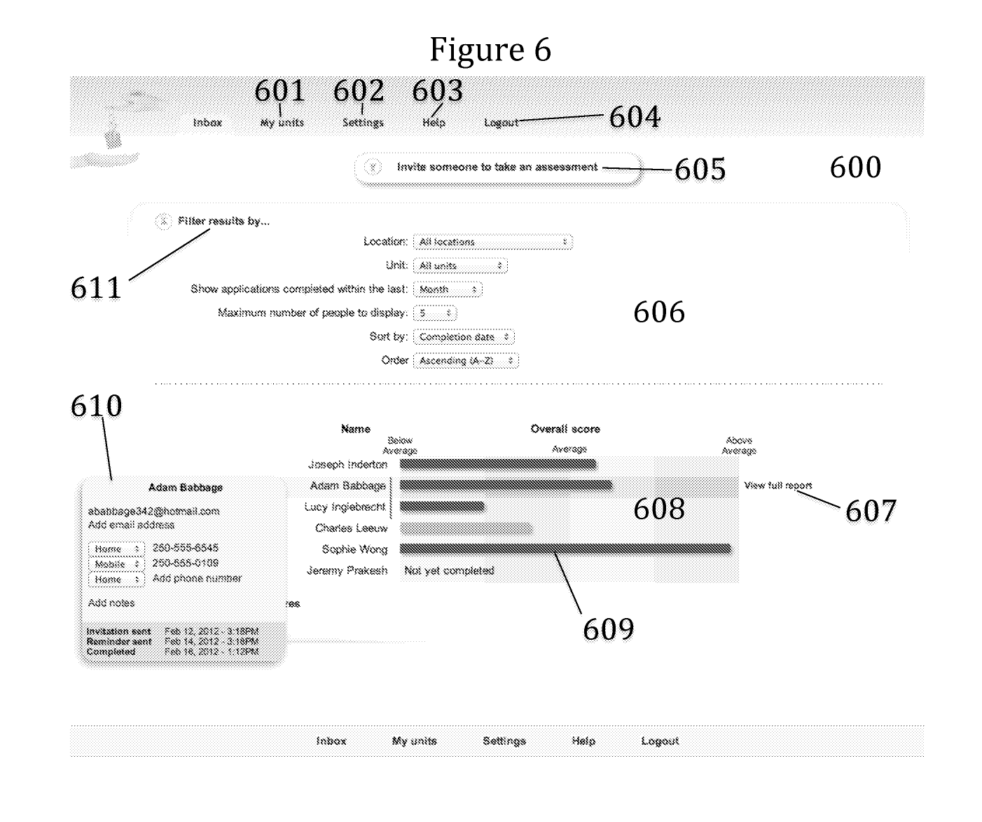

Once the landlord has logged in, he or she is taken to the inbox page illustrated in FIG. 6 as screen 600. In the embodiment shown, the inbox page 600 has four additional tabbed headers: My units 601, Settings 602, Help 603 and Logout 604. The “My units” tab 601 directs the landlord to the “My units” page (FIG. 4, screen 400). As previously discussed, that page shows the database of buildings under administration by the landlord and a description of the units within those buildings. The “Settings” tab 602 directs landlords to the “Account Settings” page (FIG. 5 screen 500 and FIG. 5A screen 520). Referring to FIG. 5, the “Account Settings” page is where landlords can purchase additional account credit 501, change their username and password 502, customize importance weights of each behavior 503, configure comparison samples used to generate percentile scores 507, manage who has access to the account 508, configure reminder emails sent to prospective tenants 509, and change the account type 510. The “Help” tab 603 takes the landlord to a menu of help topics and the “Logout” tab 604 is self-explanatory.

### Sending an Invitation to Complete an Assessment

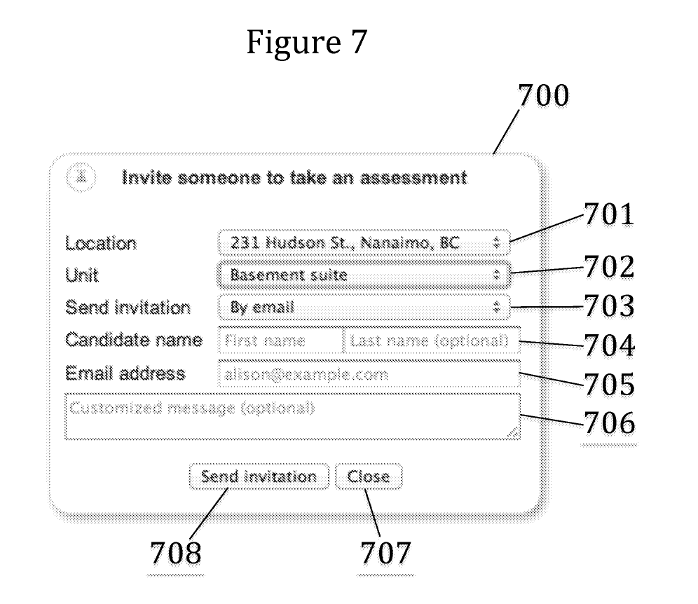

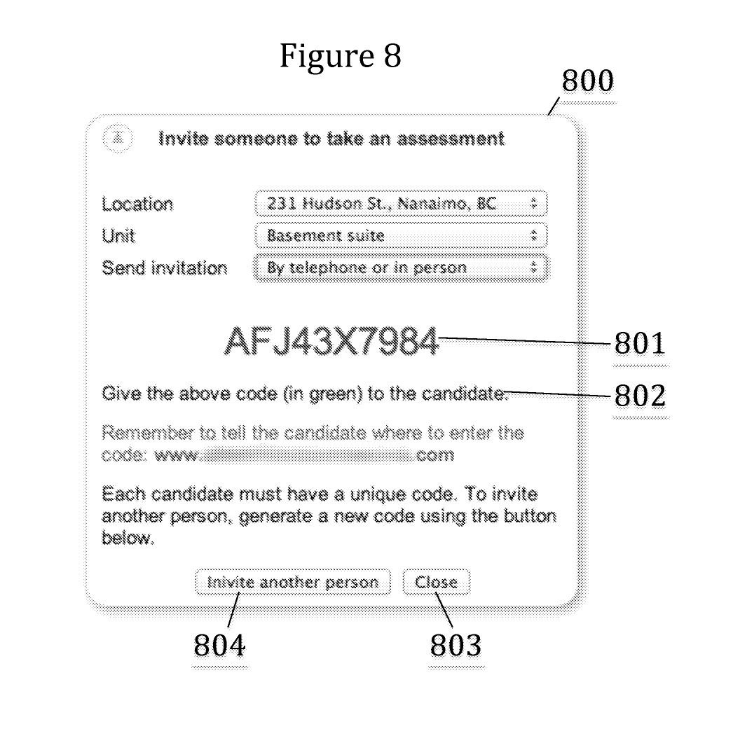

At the top of the “Inbox” page (FIG. 6, screen 600) is a form labelled “Invite someone to take an assessment” 605. This is the form generated by the invitation module of the system and used by the landlord to send prospective tenants an invitation to participate in the screening method of the invention. It is the same form as depicted in FIG. 7 screen 700 and FIG. 8 screen 800.

Still referring to FIG. 6, clicking on the “Invite someone to take an assessment” link causes the “Invite someone to take an assessment” form to expand into view (FIGS. 7 screen 700 which is the same form in a different view as FIG. 8 screen 800).

Referring to FIG. 7 and screen 700, the landlord selects the building of interest from the drop down menu 701. The landlord then selects the unit of interest from the drop down menu 702. The landlord is then presented with a choice of whether to send the invitation to the prospective tenant by email or by telephone/in person. This choice is indicated using the drop down menu 703.

The subsequent structure of the “Invite someone to take an assessment” form depends on a landlord's choice to drop down box 703. If a landlord selects the “By email” option, fields for indicating the prospective tenant's name 704, email address 705, and a customized message 706 to include in the email 705 shown on the screen 700. Upon clicking the “Send invitation” button 708, the system sends an email to the prospective tenant using the name and email address provided. The email message invites the prospective tenant to complete a personality assessment by following a link contained in the email message. Landlords can also press the “Close” button 707 to close the form 700.

Referring to FIG. 8, when the “By email or in person” option 806 is selected in the drop-down box, the “Invite someone to take an assessment” form changes into the view displayed in FIG. 8, screen 800. Landlords are shown an invitation code 801 and given instructions 802 to give the invitation code to the prospective tenant. At the bottom of the “Invite someone to take an assessment” form 800, landlords can click on a button to “Invite another person” 804, which generates and displays a new invitation code on the same form. Landlords can also click on the “Close” 803 button to close the form.

### Prospective Tenant Login

Prospective tenants require a valid invitation code as shown in FIG. 8, item 801 in order to access the personality assessment portion of the invention. Invitation codes are only valid for a predefined time (1 month), and can only be used once (i.e., one invitation code per completed personality assessment).

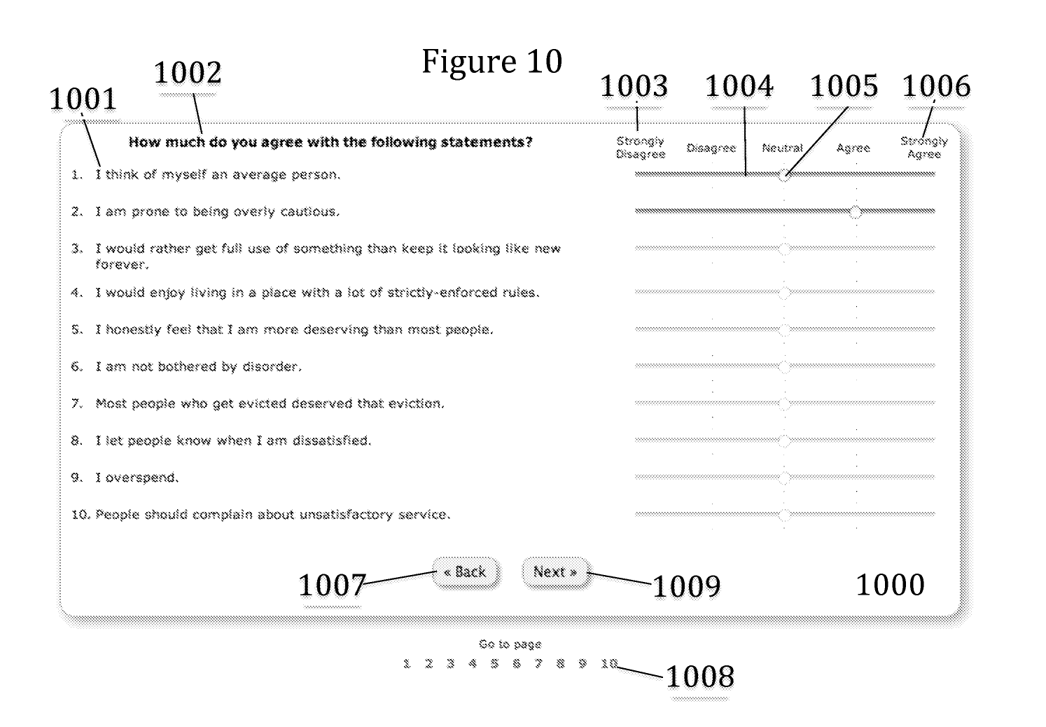

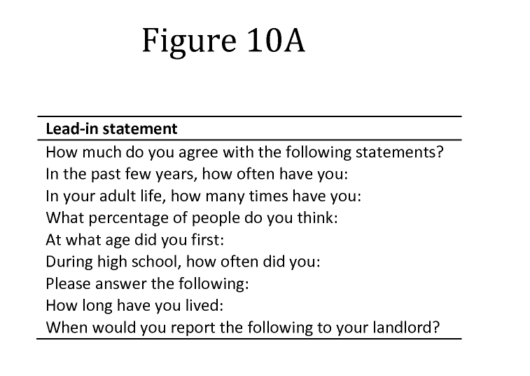

Prospective tenants who receive an invitation by email have a choice of how to login. Following a link in the invitation email immediately logs the prospective tenant in to the system, displaying the personality assessment (FIG. 10, screen 1000). Alternatively, prospective tenants can navigate to the Internet portal (FIG. 1, screen 100) and enter the invitation code contained in the email on the appropriate login screen (FIG. 1 screen 102, which is the same as FIG. 9 screen 900). Specifically, prospective tenants enter their invitation codes in the invitation code field 902 on FIG. 9, and then press the “Go” button 901.

Prospective tenants who receive an invitation by phone or in person have only one method of login. They must navigate to the Internet portal (FIG. 1, screen 100) and enter their invitation code on the appropriate login screen (FIG. 1 screen 102, which is the same as FIG. 9 screen 900).

### Administering the Personality Assessment

After login, prospective tenants can access the system of the invention. Specifically, they are provided access to the personality assessment form generated by the system assessment form module.

The personality assessment consists of statements that assess a prospective tenant's characteristics that predict behaviors of interest to landlords. Characteristics include personality traits, attitudes, judgments, and/or candidness of responses on the assessment. Prospective tenants are asked to respond to statements that may or may not be descriptive of them. One embodiment of the personality assessment is found in FIG. 10 screen 1000. The particular assessment displayed in FIG. 10 is 10 pages long and would comprise about 100 statements. For most statements, prospective tenants are given the lead-in statement (an example of which is shown at 1002) “How much do you agree with the following statements?” Alternative lead-in statements for other items are listed in FIG. 10A. For most statements, the response scale is Strongly Disagree, Disagree, Neutral, Agree, and Strongly Agree. On the particular assessment displayed in FIG. 10, the statements (examples of which are listed at 1001) are listed on each page each with a slider scale 1004. Prospective tenants slide the knob 1005 along the slider 1004 to a location that matches his or her choice between Strongly Disagree 1003 and Strongly Agree 1006. An alternative form of the same assessment may use radio buttons or drop-down menus instead of sliders for recording answers to statements. With radio buttons, each radio button corresponds to one response scale anchor for a given statement (i.e., one radio button for Strongly Disagree to statement 1, another for Disagree with statement 1, etc.). With drop-down menus, each drop-down option corresponds to one response scale anchor for a given statement.

Statements are selected automatically by the system software from a database of over 1200 statements. The process by which the system software selects statements for administration has several components. First, statement selection is partly random. Randomization enhances test security by making it extremely unlikely that any two prospective tenants will receive the same assessment. Second, statement selection is partly based on a person's responses to previous statements. Statements are chosen that are expected to provide optimal information given past responses. Third, statement selection is partly based on the importance weights for each of the tenant behaviors specified by the landlord in FIG. 5 screen 500. The system software selects statements that are most related to the behaviors of particular interest to the given landlord.

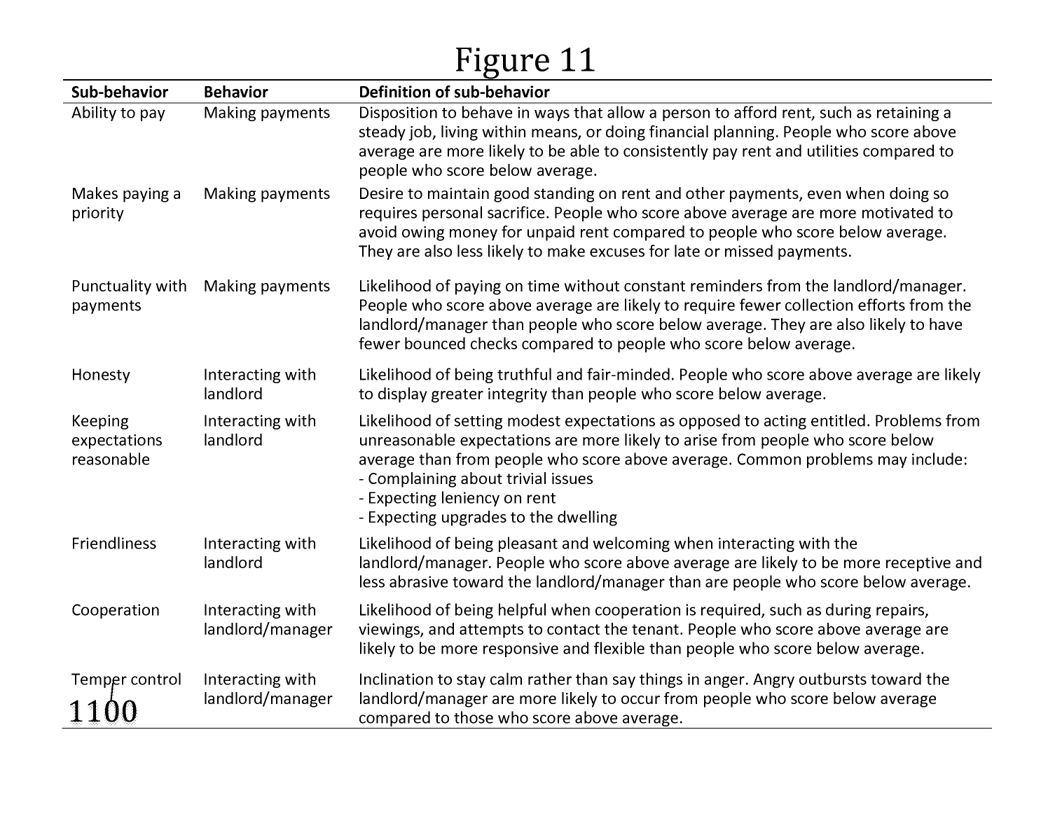

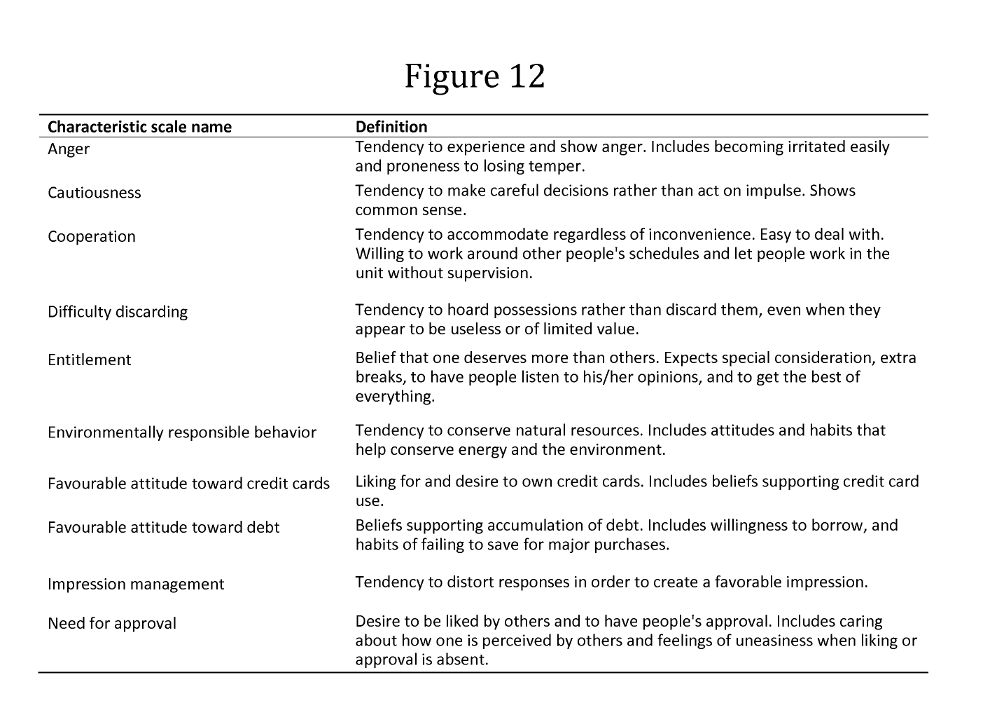

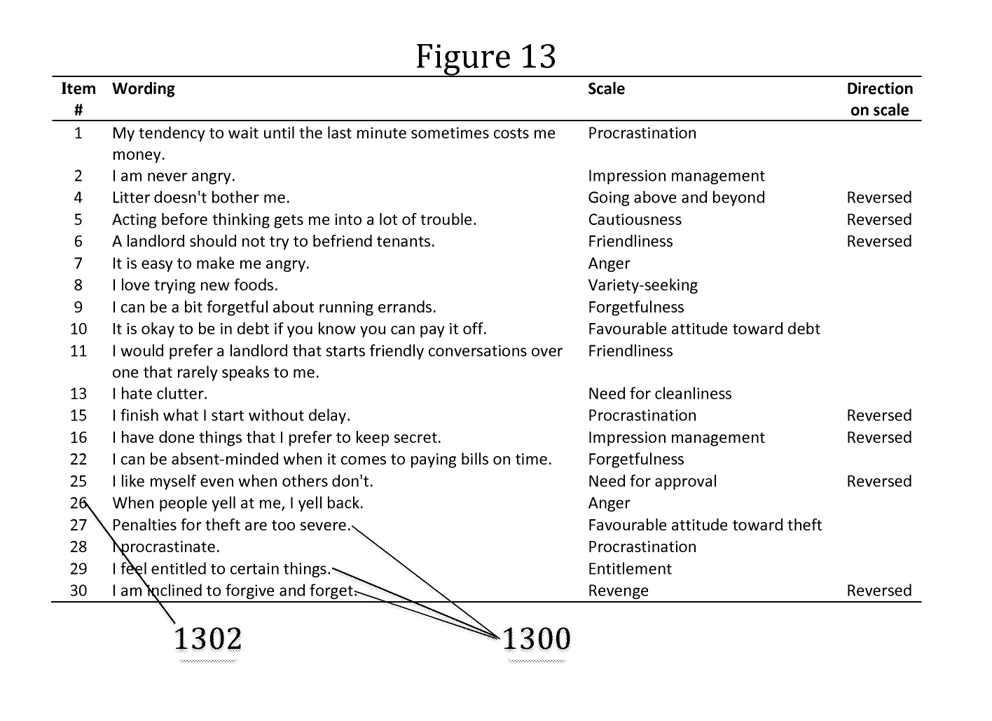

To illustrate the process that the system follows to select items for administration, consider the sub-behavior Temper Control, defined in FIG. 11 at 1100 as “Inclination to stay calm rather than say things in anger. Angry outbursts toward the landlord/manager are more likely to occur from people who score below average compared to those who score above average.” Suppose that a landlord has given Temper Control a high importance weighting on the “Importance weights of each behavior” section on FIG. 5 screen 500. The system first identifies which characteristics (listed in FIG. 12) are important for the prediction of the Temper Control sub-behavior. In the case of Temper Control, the characteristic scale of Anger (1202) is of primary importance, defined as “Tendency to experience and show anger. Includes becoming irritated easily and proneness to losing temper.” Because the prospective tenant has not yet made any responses on the personality form, the system assumes that he or she is about average on the Anger scale. The pool of Anger items currently consists of 33 items. From this pool of 33 Anger items, there may be 5 items known from research to provide optimal information for people with average levels on Anger. The system would then choose one of those 5 optimal items at random to be administered. For example, referring to FIG. 13, the system might administer item 26—“When people yell at me, I yell back.” 1302. If the prospective tenant agrees with the statement, the system infers that the prospective tenant is likely above average on the Anger scale. The next Anger item administered may be on the next page of the assessment (page 2). That item is chosen at random from a pool of items known based on previous research to provide optimal information for people suspected of being above average on the Anger scale. The prospective tenant might strongly agree with that item. If so, the next Anger item (on the third page) is chosen at random from the pool of items known to optimize information for people with a similar level of Anger as the prospective tenant's responses thus far would suggest he or she possesses.

This process—random selection from a pool of items that optimize prediction based on past responses—continues until a stopping criteria is met. The stopping criteria is that a certain level of measurement precision has been reached for the given scale, or that a predefined number of items has been administered (e.g., system stops administering Anger items after a maximum of 10 Anger items has been displayed). Given that Temper Control is of high importance to the landlord, the system may aim to obtain a higher level of measurement precision on the Anger scale than on other scales. That higher degree of measurement precision may require administration of more Anger items than would have been administered if Temper Control was less important to the landlord. If Temper Control was very unimportant to the landlord, the system may not have administered any Anger items, thus shortening the assessment and the time required to complete it.

Once stopping criteria for all scales has been met, and the prospective tenant has answered all statements, the software records that the dataset is complete and is ready for subsequent scoring.

### Scoring the Personality Assessment

Scoring the personality assessment consists of 5 main steps. These steps are outlined below and described in the paragraphs that follow.
1. Calculate scale raw scores
2. Calculate sub-behavior raw scores
3. Calculate main behavior raw scores
4. Calculate raw overall scores
5. Convert raw scores to percentile scores

In step 1, item responses are used to calculate scale raw scores. FIG. 13 shows a list of random statements or “items” 1300 selected from the statement pool of over 1200 items held in the system database. Each item measures one of over 60 tenant characteristics or “scales.” A random sample of scale names and their definitions is provided in FIG. 12. For example, item 26 on FIG. 13 “When people yell at me, I yell back” is an item/statement measuring the scale of Anger, defined as “Tendency to experience and show anger. Includes becoming irritated easily and proneness to losing temper”. Agreeing (or disagreeing) with the “yells back” statement would affect a person's scores on the Anger scale. In the initial embodiment of the invention, scale raw scores will be simple averages of all the items answered that measure the given scale. In a later embodiment (after a year of data-collection in which the system learns about the items), scale raw scores will be weighted averages. More precisely, scale raw scores will then be theta scores that represent estimates of underlying levels on the scale. Thetas are calculated using a combination of the prospective tenant's responses to the items and the item difficulty and discrimination parameters of those items. Calculations for theta will follow Samejima's (1973) method for continuous items.

In step 2, scale raw scores are used to calculate sub-behavior raw scores. A sample of sub-behaviors in one embodiment of the invention is provided in FIG. 11. Sub-behaviors (and main behaviors) were selected to represent all categories of tenant behavior that at least 1 in 1000 landlords report caring about. They were derived based on a year of proprietary research. Each scale may contribute to the scoring of one or more sub-behaviors. For example, the Anger scale may be heavily weighted in calculating the sub-behavior labelled Temper Control. The Anger scale may also contribute to scores on the Revenge sub-behavior, though may contribute less to Revenge scores than to Temper Control scores. The exact weights used to produce sub-behavior raw scores from scale raw scores will be propriety and secret. They will be regression weights that optimize prediction of the sub-behaviors. Those regression weights will be determined based on empirical research.

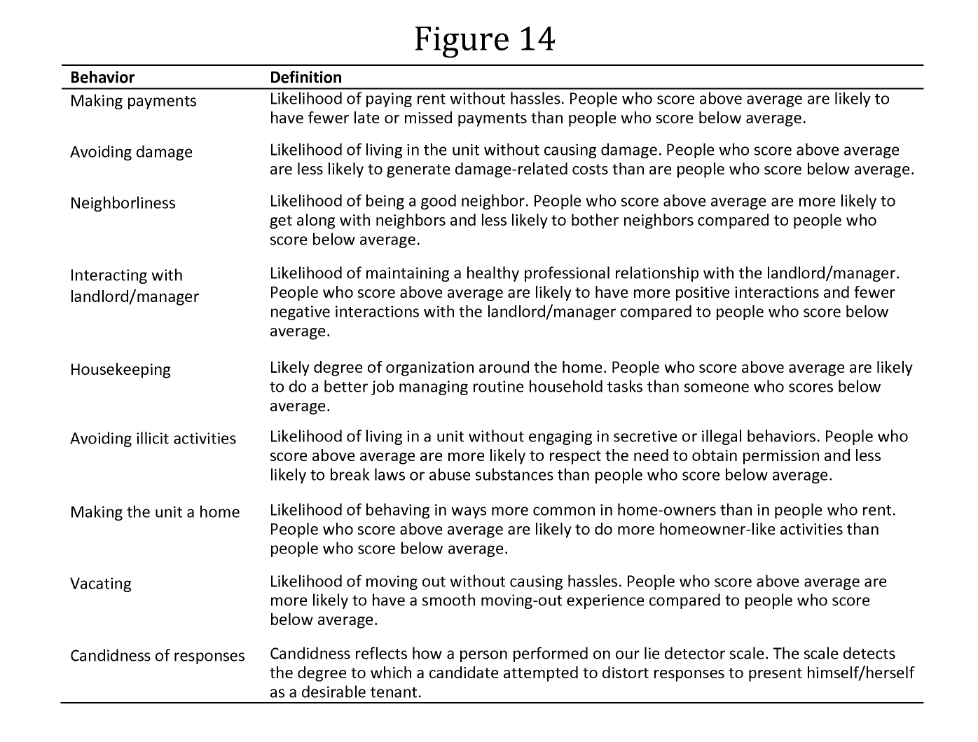

In step 3, sub-behavior raw scores are used to calculate main behavior raw scores. The main behaviors and their definitions in one embodiment of the invention are provided in FIG. 14. Like the sub-behaviors, main behaviors were derived based on a year of proprietary research. Main behavior raw scores are a weighted average of sub-behavior raw scores. Specifically, sub-behaviors raw scores are multiplied by the importance weights specified by the landlord in FIG. 5, screen 500. The sum of those products is divided by the number of sub-behaviors. The result is a weighted average representing the main behavior raw score.

In step 4, main behavior raw scores are used to calculate overall raw scores. Overall scores represent a holistic summary of the degree to which a prospective tenant is suitable for a given landlord. Just as main behavior raw scores are a weighted average of sub-behavior raw scores, overall raw scores are a weighted average of main behavior raw scores. Main behavior raw scores are multiplied by the importance weights specified by the landlord in FIG. 5, screen 500 and then averaged to produce the overall raw score.

In step 5, raw scores are converted to percentile scores. Raw scores on scales, sub-behaviors, and main behaviors have limited interpretability. It would be difficult to know whether any given raw score (e.g., 1.38) is good or bad. To increase interpretability, raw scores are converted to percentile scores. Percentile scores compare a given raw score against raw scores of similar prospective tenants as defined in a comparison sample. The comparison sample is defined by the landlord in the “Comparison samples used to generate percentile scores” section of settings page (illustrated in FIG. 5A, section 521). For example, the comparison sample may consist of applicants who have applied to units owned by that landlord, or all applicants who have applied to 1 bedroom units within a given city or distance. Percentiles reflect the number of prospective tenants in the comparison sample who scored lower than did the current individual. The exact calculation of percentile scores is as follows: (number of applicants in the comparison sample scoring lower than the applicant+½ the number of applicants in the comparison sample scoring equal to the applicant)/(number of applicants in the comparison sample).

All scoring is done by the server using a scoring module with proprietary scoring algorithms. Raw scores are calculated at the time that an assessment is completed. Percentile scores are calculated at the time that results are presented to the landlord. The scoring key is never shared with landlords.

### Comparing Results of Prospective Tenants

Landlords login using FIG. 2A screen 210 to view personality assessment scores of prospective tenants. Upon login, landlords are automatically directed to the “Inbox” page displayed in FIG. 6, screen 600.

Results comparing prospective tenants are visually displayed in section 608. In the embodiment of the invention depicted in FIG. 6, overall scores are displayed for each prospective tenant using color-coded bars 609. Bars reflect percentile scores. Scores below the 25^{th} percentile are highlighted in red; scores between the 25^{th} and 50^{th} percentiles are highlighted in orange; scores above the 50^{th} percentile are highlighted in green. Anchors are provided at the low end (Below Average), middle (Average) and high end (Above Average) of the percentile scale. Contact information and notes on prospective tenants appear in screen 610 upon hovering over any given tenant. Landlords can use screen 610 to manage contact information of prospective tenants (e.g., add/edit/delete phone numbers or email addresses), and add/edit/delete notes.

Landlords control which prospective tenants are displayed in the scoring section 608 using the “Filter results by . . . ” section 606. Clicking on the “Filter results by . . . ” link 611 makes section 606 visible. Landlords can opt to only display prospective tenants applying to a particular location, particular unit, and/or within a particular time frame. Landlords also control the maximum number of results to display, and how results are sorted.

Clicking on the name, overall score, or the “view full report” link 607 for any prospective tenant brings up that person's full report.

### Full Reports for Personality Assessment Results

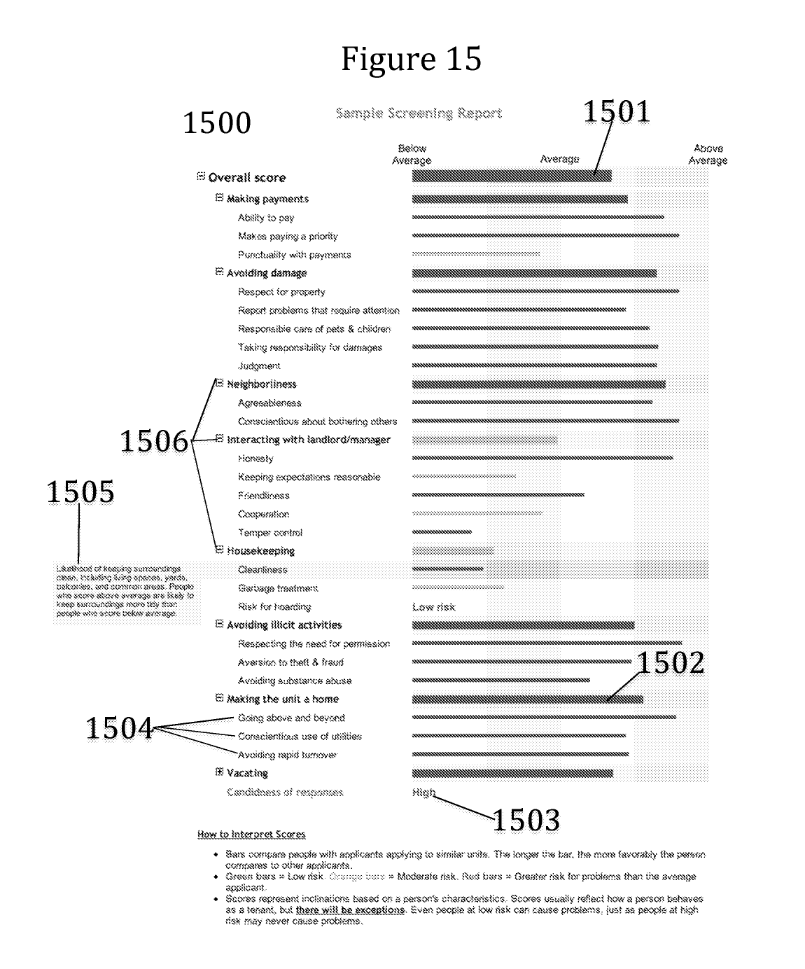

FIG. 15 is a depiction of one embodiment of the full assessment report 1500 generated by the report module and presented to the landlord. The given embodiment of the report lists all the main behaviors 1506 and sub-behaviors 1504 that have non-zero importance weightings.

Hovering over any behavior or sub-behavior automatically displays the definition 1505 of that behavior or sub-behavior.

Based on the responses of the prospective tenant on the personality assessment, and based on the scoring applied by the software, the results of the assessment are displayed as horizontal bars 1502 next to the corresponding behaviors and sub-behaviors. Consistent with the “Inbox” page, the report highlights in red scores that are below the 25^{th} percentile; scores between the 25^{th} and 50^{th} percentile appear in orange; scores above the 50^{th} percentile appear in green. Anchors are provided at the low end (Below Average), middle (Average) and high end (Above Average) of the percentile scale. The overall score 1501 is also shown at the top of the report. A “Candidness of responses” score appears at the bottom of the report. The candidness of responses score indicates the degree to which the tenant was providing candid answers on the assessment rather than trying to distort responses to create a favourable impression. All else being equal, landlords are instructed to favour prospective tenants who responded with high candour over those who responded with low candour.

Other embodiments of the report may display raw scale scores in addition to or instead of percentile scores. Other embodiments may also display the scale scores in addition to or instead of the behavior and sub-behavior scores.

In the case shown in FIG. 15, the overall score is between Average and Above Average. Though the overall score may appear satisfactory, and the candidness score is high, the landlord may still reject the prospective tenant due to low scores on some sub-behaviors. Specifically, the report indicates that the person in the report may be disposed toward bad housekeeping habits and anger control issues.

### Decision to Accept or Reject the Prospective Tenant

The invention outlined in the current document represents a new method and system for screening prospective tenants. It is a method and system that evaluates a prospective tenant's suitability based on that person's responses to a personality assessment. Though information provided by the current invention is designed to be inherently useful for guiding tenant acceptance decisions, the invention is also intended to be one component in a larger selection battery. Other components of the selection battery may include credit checks, in-person interviews, and reference checks, to name a few. The system recommends to landlords that final acceptance or rejection decisions take into consideration all available sources of information.

Process from Landlord's Perspective

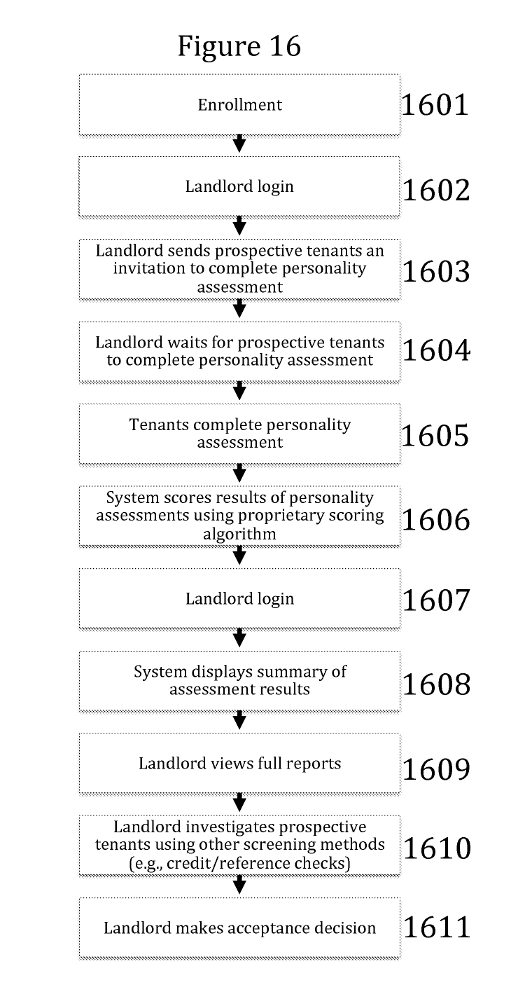

FIG. 16 illustrates a flow chart showing the primary steps of using the tenant screening system of the invention. At 1601 the landlord will open an account with the system provider and undergo an enrollment process. At 1602 the landlord will login to the system using his or her username and password. At 1603 once logged in the landlord can send an invitation to the prospective tenant to participate in the personality assessment. At 1604 the landlord will wait for the prospective tenant to complete the assessment form and may send reminders to prospective tenant if the results are not received into the system by a specified deadline. At 1605 the tenant has completed the personality assessment and the data is sent to the server where the responses of the tenant are scored using a proprietary scoring algorithm 1606. At 1607 the landlord logs into the system portal to access the inbox at 1608 and compare the results between a numbers of prospective tenants. At 1609, where the landlord wishes to view a full report of a perspective tenant the full report with interpretive information is made available. At 1610, the landlord may opt for additional screening tools such as credit or criminal record checks. At 1611 the landlord will make a final decision on which of the prospective tenants is permitted to rent the unit.

Process from Perspective of Tenant

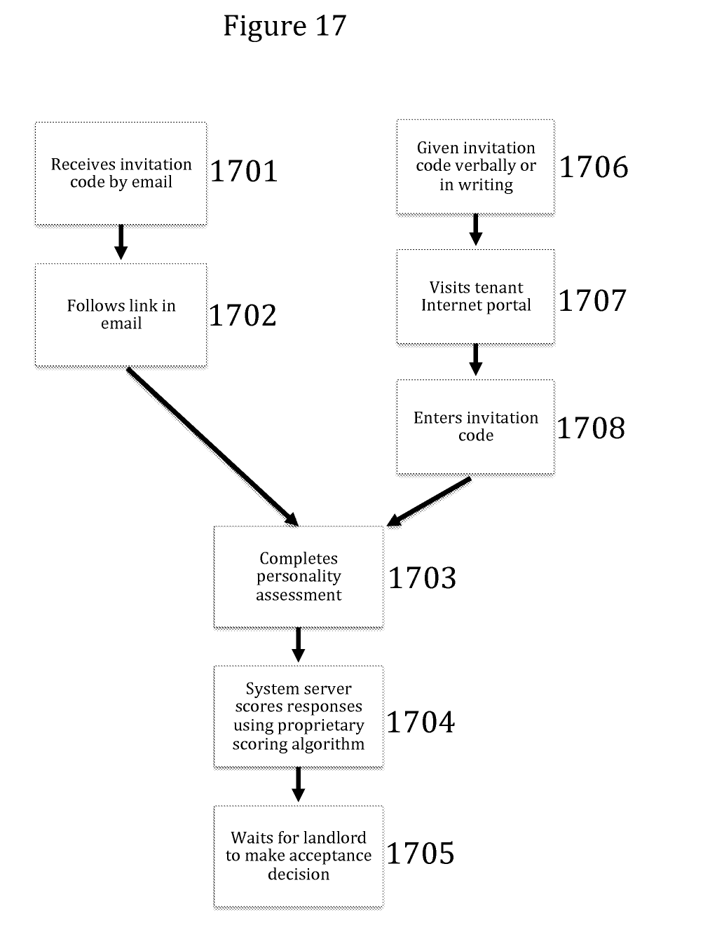

Referring to FIG. 17, the landlord can send the tenant an invitation to participate in the personality assessment either by email at 1701 or verbally by telephone or in writing at 1706. If by email, the prospective tenant will follow the link provided in the email at 1702. The link takes the prospective tenant to the personality assessment 1703. The prospective tenant completes the assessment and the system server scores the assessment results using a proprietary scoring algorithm 1704. The results are presented to the landlord who makes a decision 1705 as to who will be renting. Where the invitation is delivered by means other than email, the prospective tenant will log in to the server through the system Internet portal 1707. The prospective tenant will enter the invitation code at 1708 and then be taken to the assessment at 1703.

The preceding description has been presented only to illustrate and describe possible embodiments of the present exemplary system and method. It is not intended to be exhaustive or to limit the system and method to any precise form disclosed. Many modifications and variations are possible in light of the above teaching. It is intended that the scope of the present invention system and method be defined by the following claims.

What is claimed is:

1. A method for evaluating the suitability of a prospective tenant for a rental unit based on results of a personality assessment comprising the use of a computerized selection system comprising computer processors and software programs, wherein said method comprises the steps of:
a. Identifying said prospective tenant;
b. Providing an Internet portal so that said landlord can access said computerized selection system;
c. Permitting the landlord permission-based access to the computerized selection system through said landlord Internet portal;
d. Sending an invitation to the prospective tenant to participate in said screening method;
e. Providing a prospective tenant access to said Internet portal so that the prospective tenant can access the computerized selection system;
f. Permitting the prospective tenant permission-based access to the computerized selection system;
g. Providing to the prospective tenant a personality assessment comprising a plurality of statements that assess personality traits, attitudes, judgments, and/or candidness of responses on the assessment;
h. The prospective tenant providing responses to said plurality of statements thereby creating a dataset;
i. The computerized selection system using said software programs for scoring said dataset using a proprietary scoring algorithm; and,
j. The computerized selection system generating an assessment report summarizing suitability results about the prospective tenant for the landlord.

2. The method of claim 1 wherein the step of permitting the landlord permission-based access to the computerized selection system through the Internet portal comprises the steps of:
a. The landlord enrolling in the computerized selection system on a subscription or a pay-per-use basis;
b. The landlord providing a plurality of suitable identification data to said computerized selection system;
c. The landlord choosing an email address and password to access said computerized selection system; and,
d. Said computerized selection system establishing an account for the landlord.

3. The method of claim 1 wherein the step of sending said invitation to the prospective tenant to participate in said screening method comprises the steps of:
a. The computerized selection system providing a menu of properties under the landlord's administration;
b. The landlord identifying a property from said menu of properties in which the prospective tenant wishes to rent;
c. The computerized selection system providing a menu of options for ways to invite prospective tenants to complete the personality assessment comprising one of email, mail and telephone;
d. The landlord selecting one of said options identified in step (c).

4. The method of claim 3 wherein the landlord has selected email and wherein the method further comprises the steps of
a. The landlord inputting the prospective tenant's email address into an appropriate data field;
b. The computerized selection system generating an invitation code for use by the prospective tenant; and,
c. The computerized selection system sending said invitation code to the prospective tenant's email address.

5. The method of claim 4 wherein the prospective tenant accesses the Internet portal.

6. The method of claim 5 wherein the prospective tenant enters the invitation code into an appropriate data field displayed on the Internet portal permitting the prospective tenant permission-based access to the computerized selection system.

7. The method of claim 6 wherein upon entering the invitation code the prospective tenant is provided access to said personality assessment.

8. The method of claim 1 wherein the step of scoring the dataset comprises the steps of:
a. Calculating raw scale scores;
b. Combining said raw scale scores to calculate raw sub-behavior scores;
c. Combining said raw sub-behavior scores to calculate raw behavior scores;
d. Combining said raw behavior scores into an overall acceptance recommendation score;
e. Calculating a percentile score for each raw score comprising an overall acceptance recommendation raw score, a behavior raw scores, a sub-behavior raw scores and a scale raw scores; and,
f. Displaying a set of requested scores on said assessment report.

9. The method of claim 8 wherein the step of calculating said raw scale scores comprises the step of the computer software programs producing an average or weighted average of a set of items contributing to a scale responded to by the prospective tenant.

10. The method of claim 9 wherein the step of calculating said raw sub-behavior scores comprises the step of the computer software programs combining the raw scale scores with a suitable set of regression weights for optimizing prediction of sub-behaviors for the prospective tenant.

11. The method of claim 10 wherein the step of combining the raw sub-behavior scores into said raw behavior scores comprises the following steps:
a. The landlord selecting and weighting the importance of sub-behaviors;
b. The computerized selection system recording said set of importance weights; and,
c. The software program calculating a weighted average for each behavior based on said importance weights of the corresponding sub-behaviors that comprise each behavior.

12. The method of claim 11 wherein the step of combining the raw behavior scores into said overall acceptance recommendation score comprises the following steps:
a. The landlord selecting and weighting the importance of the behaviors in the overall acceptance recommendation score;
b. The computerized selection system recording said set of importance weights;
c. The software program calculating a weighted average based on said importance weights of the behaviors.

13. The method of claim 12 wherein the step of calculating said percentile score for each raw score comprises the computer software executable steps of:
a. The landlord specifying a comparison sample to be used in comparing scores and generating percentile score information;
b. Obtaining the given raw score for the prospective tenant (i.e., the overall acceptance recommendation raw score, behavior raw score, sub-behavior raw score, or scale raw score);
c. Calculating a percentile score for the given raw score derived based on comparison of the raw score to said comparison sample; and
d. Generating said assessment report in a graphic manner to the landlord.

14. The method of claim 13 wherein the steps of obtaining said normative percentile score is derived from said comparative sample set chosen by the landlord as an appropriate sample for use in comparing prospective tenants who applied to a given rental unit.

15. The method of claim 14 wherein said percentile score describes a percentage of the comparison sample set having a raw score lower than corresponding raw of the prospective tenant.

16. The method of claim 15 wherein the step of generating the assessment report includes the step of displaying behaviors and sub-behaviors with a non-zero importance weighting.

17. A system for evaluating the suitability of a prospective tenant for a rental unit by a landlord comprising:
a. A computerized selection system comprising:
i. a computer processing module;
ii. a software program module; and,
iii. at least one memory module;
b. An Internet portal so that said landlord and said prospective tenant can access said computerized selection system;
c. An invitation module for generating an invitation to the prospective tenant to participate in said screening method, said invitation module comprising:
i. a connection to an email system;
ii. a prospective tenant e-mail address; and,
iii. a system generated invitation code for use by the prospective tenant for accessing the system.
d. A security module permitting the landlord and prospective tenant permission-based access to the computerized selection system, said security module comprising:
i. a system administrator;
ii. a landlord enrollment module;
iii. a fee payment module; and,
iv. a landlord password management module.
e. A personality assessment module comprising a plurality of items associated with a plurality of scales
f. A weighting module whereby the landlord can weight tenant behaviors;
g. A comparison sample module whereby the landlord can define the comparison sample used for calculating percentile scores;
h. A prospective tenant-generated dataset;
i. A dataset scoring module; and,
j. An assessment report generating module for the landlord.

18. The system of claim 17 wherein the software program module comprises a scoring key for scoring the dataset wherein said scoring key calculates:
a. A raw scale score;
b. Several raw sub-behavior scores;
c. Several raw behavior scores;
d. An overall acceptance recommendation raw score;
e. A percentile score for each raw score; and,
f. Requested scores for display on said assessment report.

19. The system of claim 18 wherein said raw sub-behavior scores are comprised of weighted raw scale scores using a suitable set of regression weights for optimizing a prediction of behaviors of the prospective tenant.
